(19) United States
(12) Patent Application Publication
(10) Pub. No.: US 2024/0359579 A1
(43) Pub. Date: Oct. 31, 2024

(54) AN ELECTRIC VEHICLE HYBRID AIR CONDITIONING SYSTEM CONFIGURED FOR CHARGING AN ELECTRIC VEHICLE

(71) Applicant: PUMA SOCIAL LIMITED, Clane, Co. Kildare (IE)

(72) Inventors: Jeffrey AHERNE, Celbridge, Co. Kildare (IE); John BYRNE, Lucan, Co. Dublin (IE); Darran FAHERTY, Celbridge, Co. Kildare (IE)

(21) Appl. No.: 18/579,555

(22) PCT Filed: Jul. 16, 2021
(86) PCT No.: PCT/EP2021/070049

§ 371 Date: Jan. 16, 2024

(51) Int. Cl. B60L 53/302; B60H 1/00; B60L 53/60; B60L 55/00

(52) U.S. Cl. CPC B60L 53/302; B60H 1/00385; B60H 1/0073; B60L 53/60; B60L 55/00

(57) ABSTRACT

An electric vehicle hybrid air conditioning system configured for charging an electric vehicle is described. The electric vehicle hybrid air conditioning system comprises at least one air conditioning unit for conditioning a space or medium. At least one electrical vehicle supply equipment (EVSE) is provided for charging at least one electric vehicle. At least one control means is provided for controlling the at least one air conditioning unit and the at least one electrical vehicle supply equipment

### FIELD OF THE INVENTION

The present disclosure relates to an electric vehicle hybrid air conditioning system configured for charging an electric vehicle.

### BACKGROUND OF THE DISCLOSURE

An air conditioner typically includes the following components but not limited to. A heat exchanger; four way valve; a condenser; an expansion valve; and power electronics boards which may include a power board, an invertor board, and a controller board. These are the common parts in a heat exchanger, hybrid air conditioning system, refrigerant system, heat pump or any other system which has the function of cooling or heating a medium for the purpose of controlling or moderating a temperature within that medium and will be referred to as an air conditioner from here on. Air conditioners can be located externally of a building or in secluded areas of a structure, for example, an underground car park which lends to their accessibility for electric vehicles.

An electric vehicle charging station, also called EV charging station, electric recharging point, charging point, charge point, electronic charging station (ECS), electric vehicle supply equipment (EVSE), Fast charger, DC fast charger and wireless charging station, is a machine that supplies electric energy for the recharging of electric vehicles—including plug-in electric vehicles, neighbourhood electric vehicles, hybrid electric vehicles, wireless electric vehicles, flying electric taxis, electric motorbikes and any other types of electric vehicles.

IEC 61851-1 is an international standard where the general requirements for EVs conductive charging systems are disclosed. According to the IEC 61851-1 standard, the charging of electrical vehicles can be done in four ways. Mode 1 is the simplest solution for charging electric vehicle (EV). In this case the EV is connected to the residence standard socket outlets but must have a circuit breaker for overload and earth leakage protections. In this mode the charging is realized without communication and it is rated up to 16 Amp. Mode 2 where the EV is connected to the domestic power grid via a particular cable with in-cable or in-plug control pilot and a protection device. The current must not exceed 32 Amp.

Mode 3 where the EV is connected via specific socket on a dedicated charging station that has permanently installed the control and the protection functions. The rated charging current is up to 3×63 Amp. Mode 4, where the EV is fast charging in direct current (DC).

The widely accepted climate change theory has forced governments into rethinking how we use and create energy as well as monitoring and reducing the overall level of emissions. Fossil fuels are to be phased out over time. Two of the largest users of energy are transport (42% in Ireland 2018) and heating or cooling (39% in Ireland 2018).

Electric vehicles are seen as a logical step to replace the internal combustion engine. To this end 2020 saw global electric vehicle sales grow by 41%. Growth will continue through this decade and beyond, with the number of EVs registered around the world increasing from about 10 million today to 145 million in 2030 according to the IEA report released in late April, “Global EV Outlook 2021” (https://www.iea.org/reports/global-ev-outlook-2021/introduction#abstract.) It cannot be accurately predicted how the owners and users of EV's will charge their cars in the future. One thing is clear, flexibility, speed and cost of charging will factor in any decision.

The current charging infrastructure for electric vehicles is significantly below what is needed to meet the increasing demand for EVs. The lack of charging points for EVs may deter consumers from purchasing an EV in the future without a large increase in the number of available charging points. Households without on street parking or parking at their house will need the use of charging stations. That is at least 1.5 million households in the United Kingdom alone.

The world will move away from gas and oil burners/boilers and the logical next steps are Heat Pumps. Hot countries also use air conditioning as a way to cool and sometimes heat a space. Heat pumps and air conditioning units are considered one in the same. Heat pumps could satisfy 90% of global heating needs with a lower carbon footprint than gas-fired condensing boilers. Nearly 20 million households purchased heat pumps in 2019. Yet it still only represents 5% of the requirement according to the IEA. https://www.iea.org/reports/heat-pumps. That's another 380m units, Ireland alone requires 600,000 units to satisfy its needs,

In addition, the process of charging an electric vehicle generates heat. The higher the power the greater the heat loss from the components. Smaller systems such as type 1 and 2 chargers produce minimal heat. Any heat loss is generally dissipated in the surrounding air either through a heat sink or small fan. However on larger systems greater than 10 kW, cooling mechanisms are required. Generally this takes the form of some kind of direct expansion coil with a refrigerant and the heat is generally dissipated through cooling.

Now and in the future a household will require an EV charger and an air conditioning system. These can be installed separately at a large cost and less control without expensive control modules being added.

### SUMMARY OF THE INVENTION

These and other problems are addressed by providing an electric vehicle hybrid air conditioning system configured for charging an electric vehicle as detailed in claim 1. Advantageous features are provided in dependent claims.

Accordingly there is provided an electric vehicle hybrid air conditioning system configured for charging an electric vehicle; the electric vehicle hybrid air conditioning system comprising:
at least one air conditioning unit for conditioning the temperature of a space or medium;
at least one electrical vehicle supply equipment (EVSE) for charging at least one electric vehicle; and
a control means for controlling the at least one air conditioning unit and the at least one electrical vehicle supply equipment.

In one embodiment: the control means is operable to give priority to the air conditioning unit over the at least one EVSE or vice versa. Advantageously; the control means is operable to prioritise power supply to the air conditioning unit over the at least one EVSE; or vice versa.

In an exemplary embodiment; the control means is operable to operate a master slave relationship between the at least one air conditioning unit and the at least one EVSE; or vice versa

In a further embodiment; the control means allows the electric vehicle to operate as a secondary power source for the air conditioning unit.

In another embodiment; the control means comprises a current sensing circuit.

In one embodiment: the control means comprises a signal monitoring circuit.

In an exemplary embodiment; the control means is operable to reverse power from the electric vehicle to the air conditioning unit.

In a further embodiment; the control means comprises a first controller for controlling the at least one air conditioning unit; and a second controller for controlling the at least one electrical vehicle supply equipment. Advantageously; the first controller is configured as a master; and the second controller is configured as a slave.

In another embodiment; at least one power converter is provided for converting power from a power source to a suitable format for powering the air conditioning unit. Advantageously; the at least one power converter is configured for converting power from the power source to a suitable format for charging the electric vehicle.

In one embodiment; the current sensing circuit is operable for measuring current being fed to the air conditioning unit and/or the EVSE.

In another embodiment: wherein the control means is operable for varying the supply of current to the electric vehicle based on an operational characteristic of the air conditioning unit.

In an exemplary embodiment; the control means is configured for facilitating bidirectional power flow between EVSE, the air conditioning unit and the electric vehicle. Advantageously: the control means is operable to reverse the direction of power in response to an operational characteristic of the air conditioning unit.

In another embodiment; the control means is operable to reverse the direction of power in response to an operational characteristic of the power source.

In an exemplary embodiment; the air conditioning unit comprises a cooling means. Advantageously; the cooling means may be a cooling loop circuit.

In one embodiment; the electric vehicle hybrid air conditioning system further comprises a DC electric charger or a wireless EV charger.

In an exemplary embodiment: the cooling means comprises a cooling loop circuit and/or a charger cable cooling circuit.

In another exemplary embodiment; a charging cable may be cooled as the speed of charge increases. In a 90% efficient system a 50 kw charger would lose 5 kw through heat dissipation which is relatively insignificant however as the speed increases towards 350 kw this is significantly greater at 35 kw so hence a cooled cable will increase efficiency of the charging process. The loss maybe defined as Pwaste=Pout((1/n)−1).

In an exemplary embodiment; heat is recovered by the electric vehicle hybrid air conditioning system from the charger cooling loop circuit.

These and other features will be better understood with reference to the following figures which are provided to assist in an understanding of the present teaching, by way of example only.

### BRIEF DESCRIPTION OF THE DRAWINGS

FIG. 1 illustrates a block diagram of an exemplary electric vehicle hybrid air conditioning system configured for charging an electric vehicle in accordance with the present teaching.

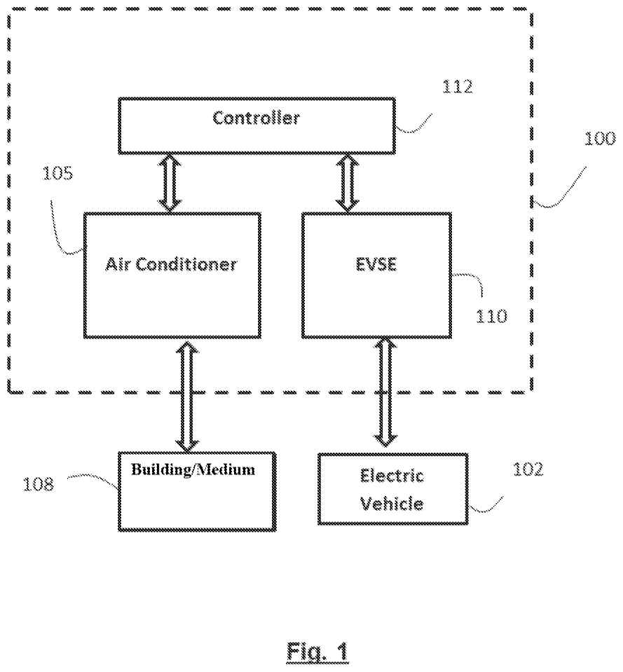

FIG. 2 illustrates a block diagram of a detail of the electric vehicle hybrid air conditioning system of FIG. 1.

FIG. 3 illustrates a circuit diagram of a detail of the electric vehicle hybrid air conditioning system of FIG. 1.

FIG. 4 illustrates a circuit/sampling diagram of a detail of the electric vehicle hybrid air conditioning system of FIG. 1.

FIG. 5 illustrates a circuit diagram of a detail of the electric vehicle hybrid air conditioning system of FIG. 1.

FIG. 6 illustrates a block diagram of another exemplary electric vehicle hybrid air conditioning system configured for charging an electric vehicle which is also in accordance with the present teaching.

FIG. 7 illustrates a block diagram of another exemplary electric vehicle hybrid air conditioning system configured for charging an electric vehicle which is also in accordance with the present teaching.

FIG. 8 illustrates a block diagram of another exemplary electric vehicle hybrid air conditioning system configured for DC charging an electric vehicle which is also in accordance with the present teaching.

FIG. 9A shows an example of the addition of a cooling loop circuit in the electric vehicle hybrid air conditioner to a EV charger on a 2 pipe variable refrigerant flow system.

FIG. 9B shows an example of a 2 pipe variable refrigerant flow system where an EV charger is connected using an extended cooling loop circuit to allow flexibility in placement of the EV charger.

FIG. 9C shows an example of the addition of a cooling loop circuit in an electric vehicle hybrid air conditioning system to an EV charger on a 3 pipe variable refrigerant flow system. In addition this diagram includes an example of the addition of a cooling loop circuit on a charging cable added to the system for further heat recovery.

FIG. 9D shows an example of a 3 pipe variable refrigerant flow system where an EV charger is connected using an extended cooling loop circuit to allow flexibility in placement of the charger. In addition a cooling loop circuit from a charging cable has been added to the extended system for further heat recovery.

FIG. 10 is a block diagram illustrating a configuration of the control means which may be provided by a computing device.

FIG. 11 is a flow chart illustrating exemplary steps of a method for controlling a hybrid air conditioning system

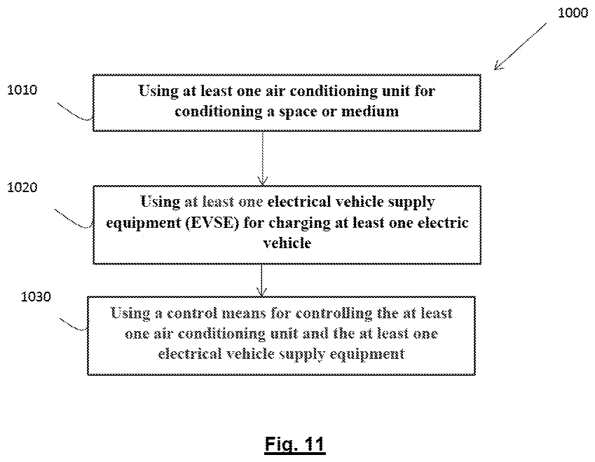

### DETAILED DESCRIPTION

Embodiments of the present disclosure will now be described with reference to some exemplary electric vehicle hybrid air conditioning systems configured for charging an electric vehicle and exemplary methods for controlling the electric vehicle hybrid air conditioning system. It will be understood that the embodiments described are provided to assist in an understanding of the present disclosure and are not to be construed as limiting in any fashion. Furthermore, modules or elements that are described with reference to any one figure may be interchanged and/or combined with those of other figures or other equivalent elements without departing from the spirit of the present disclosure.

Referring to the drawings there is illustrated a hybrid air conditioning system 100 configured for charging an electric vehicle 102. The electric vehicle hybrid air conditioning system 100 comprises an air conditioning unit 105 for conditioning a space or medium within a structure or building 108. An electrical vehicle supply equipment (EVSE) 110 is provided for charging the electric vehicle 102 which would typically be located in the vicinity of the building 108 or structure. A control means 112 is provided for controlling the air conditioning unit 105 and the EVSE 110.

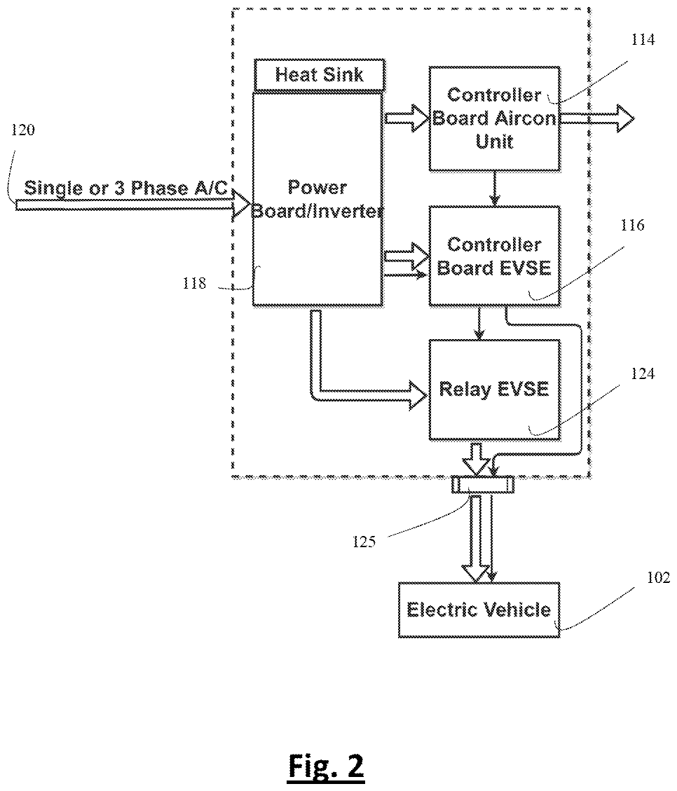

Referring to FIG. 2 there is illustrated an exemplary electric vehicle hybrid air conditioning system 100 in accordance with the present teaching which is configured as a unidirectional AC Charger Mode 2-3. The control means 112 comprises a first controller 114 associated with the air conditioning unit 105; and a second controller 116 associated with the EVSE 110. A power circuit 118 is provided for receiving power from a power source 120 and for converting the power to be suitable for powering the air conditioning unit 105 and the EVSE 110. In the exemplary embodiment; the power source 120 may be single phase or 3 phase. The power source 120 feeds the power circuit 118 which in turn feeds the first controller 114, the second controller 116 and to an EVSE Relay 124. The control means 112 may be configured such that it is capable of measuring and delivering a variable current to the EVSE 110 such that the EVSE operates at a reduced power while the air conditioning unit 105 operates at full power or close to full power or at a desired power. It will be appreciated by those skilled in the art that the control means may be configured to prioritise the air conditioning unit 105 over the EVSE 110 or vice versa. A connection from the EVSE relay 124 may use a tethered cable or an untethered cable using a standard male/female connector 125 or whichever industry standard is available. The control boards, power boards, invertors or any components for the air conditioning unit 105 and the EVSE 110 may be integrated onto the same Integrated Circuit board (IC) or separated to fit the components within the unit.

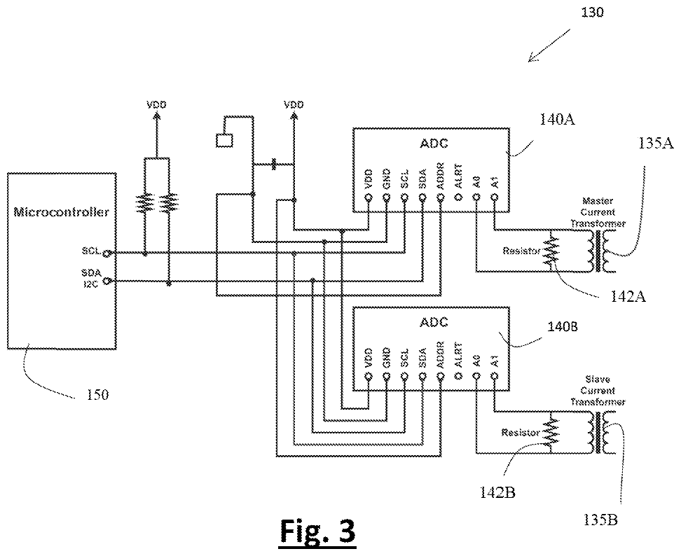

In order to vary the amount of current supplied to the EVSE to charge the electric vehicle 102 while also ensuring that the air conditioner 105 is prioritised such that it may operate at full power the control means may include a current sensing circuit 130 as illustrated in FIG. 3. It will be appreciated by those skilled in the art that the current sensing circuit 130 is provided by way of measuring power as an example only and it is not intended to limit the disclosure to the exemplary circuit described. In the exemplary current sensing circuit 130 the air conditioner unit 105 and the EVSE 110 are controlled in a master-slave relationship. The primary purpose of the current sensing circuit 130 is to distinguish how much current remains available for use by the EVSE 110 by comparing the amount of current being used by the air conditioner unit 105 with the input current 120. Two current sensors/transformers 135A, 135B are provided for measuring the total current. The current sensor 135A is associated with the air conditioning unit 105 and is configured as the master while the current sensor 135B is associated with the input current to the electric vehicle hybrid air conditioning system 120 and is configured as a slave. The slave current sensor 135B measures the total current available at the input A/C line. An analogue to digital converter (ADC) 140B converts the sensed current.

A current signal is received from the master current sensor 135A. This will be read as a voltage and using a resistor 142A to drop the voltage to a suitable value which an ADC will read. The current sensing circuit 130 is configured for a differential reading which will allow the ADC to measure both the positive and negative of an AC oscillation. The same measurement will be taken from the slave current sensor 135B. In this case the slave is measuring the current on the input AC power source. Once again using a correctly sized resistor 142B with a set value for the system will allow an appropriate level of voltage return into the ADC. In the exemplary embodiment, the resistor 142B will be designated based on peak voltages and not the rms voltages in order to keep within the safe operation limitations of the ADC. The readings from both ADCs 140A, 140B are required to be converted to a comparable voltage number using gains with the programming of the ADC. FIG. 3 illustrates a simplified version I²C bus 139 connecting both ADCs 140A, 140B to a microprocessor/microcontroller 150.

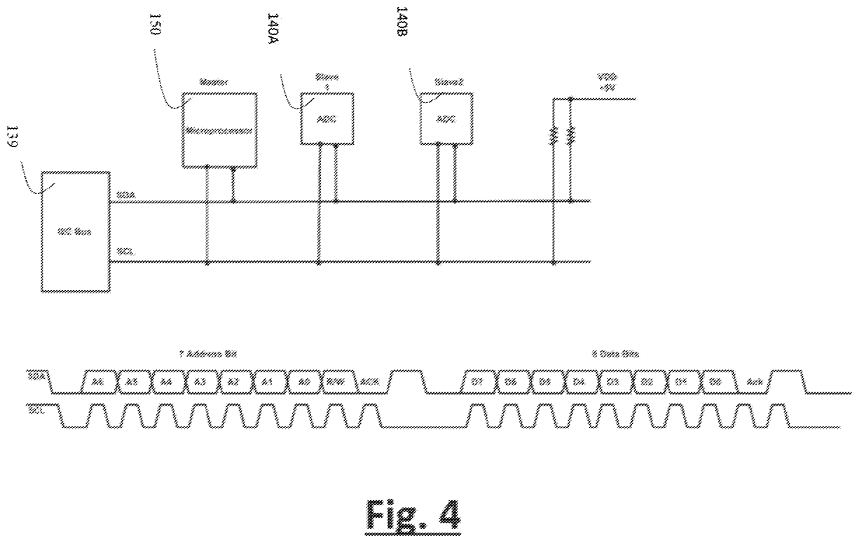

Referring to FIG. 4; the microcontroller 150 may be used to read both from Slave 1 ADC 140B and Slave 2 ADC 140B. Slave 1 ADC will have measured from the master current sensor 135A with slave 2 having measured for the slave current sensor 135B.

The microprocessor 150 may be configured to sample the current levels of each ADC as a voltage signal giving a remaining value using the Serial data (SDA) and Serial Clock line (SCL) of the I²C bus 139. The SCL is driven by the SDA line going low to start the interrogation sequence, followed by the individual address for each slave and in this case followed by a read by signal by the master to take data from the designated slave as an 8 bit data bundle. The master reads the data from each cycle as the clock goes low. Once processed a small percentage correction will be applied to the system to allow for inaccuracies within the design of the sensors, a final remaining output current available will be fed to the EVSE microcontroller to advertise as a max available current. The value of current available may range from full power available for charge, down to no power (less than 6 amps) remaining available, due to the air conditioner running at a high power.

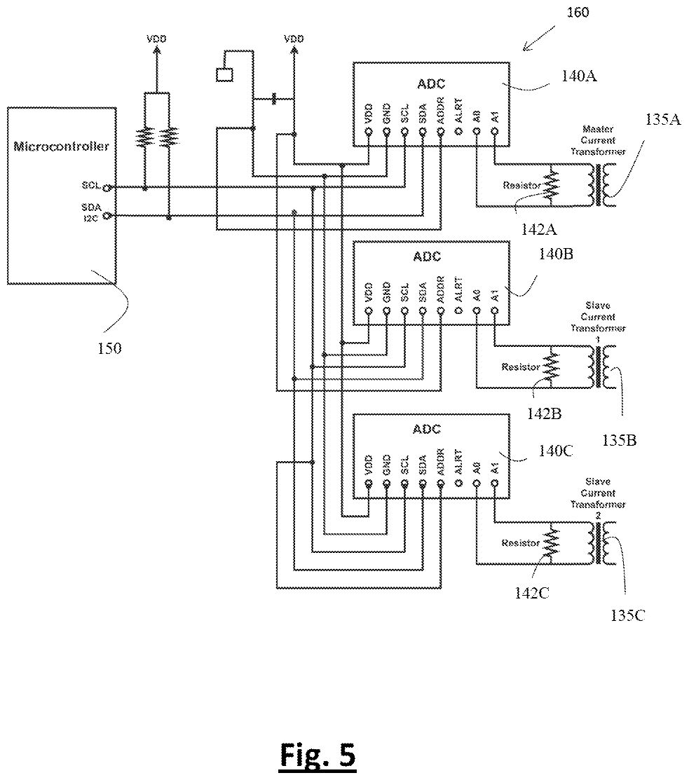

Referring to FIG. 5; is an example of an energy power monitor 160 which includes the current sensing circuit 130 and similar components are indicated by similar reference numerals. It will be appreciated by those skilled in the art that the energy power monitor 160 is provided by way of an example only and it is not intended to limit the disclosure the exemplary circuit described. The additional ADC 140C with current measurement sensor 135C added to the I²C circuit will measure the external current being fed to either the external meter or directly from the fuse board. The further protection is required due to the large additional electric draw being placed on a building with the upgrade from oil or gas to a heat pump/hybrid air conditioning system. A dwelling in the past would have heat supplied by oil or gas and the car supplied by petrol or diesel. This is now changing through upgrades of the heating system however without upgrade to the feed supply from the mains. By measuring the mains current supply and additionally possibly the voltage supply of the system one can monitor the power being drawn by the network prior to the feed for the electric vehicle hybrid air conditioner system 100 being used. If for any reason the air conditioner requires to increase power to run effectively it may try to draw more amps than what is available in the remaining network supply. This would cause the fuse board to trip. To prevent this from happening a similar design to FIG. 5 the air conditioner can be power limited and controlled using the energy monitoring system. In this case the air conditioner can only draw what remains available in the electrical system with the mains feed being the master, the input feed to the electric vehicle hybrid air conditioner system being slave 1 and the air conditioner being slave 2 in the diagram. This method of control will guarantee the end user will have full control and safety of their fuse board without ever overloading due to numerous power heavy appliances running at the same time, with the circuit board being priority No. 1, the air conditioner No. 2 and the EVSE No. 3 in priority for the system or vice versa.

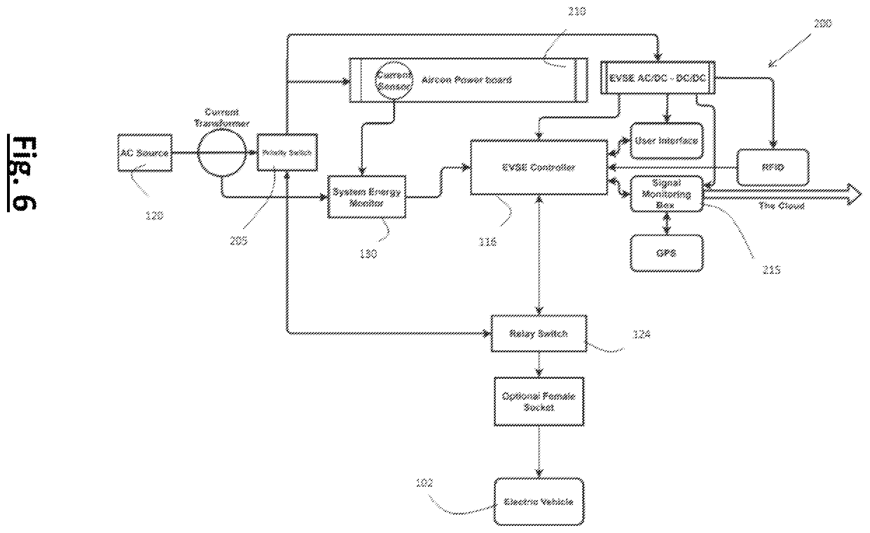

Referring to FIG. 6; there is illustrated another electric vehicle hybrid air conditioning system 200 which is also in accordance with the present teaching. The electric vehicle hybrid air conditioning system 200 is substantially similar to the electric vehicle hybrid air conditioning system 100 and like components are indicated by similar reference numerals. The electric vehicle hybrid air conditioning system comprises V2G technology for reverse powering of the air conditioning unit 105 through a priority switch 205 or similar technology and into the air conditioner power board 210. In addition to the V2G technology there is also provided an optional signal monitoring box 215 which can be connected to the cloud through either a hard wire, Wifi, GSM or any other means. The signal sent can include multiple points of information which may be sent through the cloud directly to the vehicle 102 and/or also through an app. All of the data sent will be in compliance with Intelligent Transportation Systems (ITS) IEEE 802.11, IEEE 802.11p, IEEE 1609, SAEJ2354, SAEJ2369 and all other relevant standards for vehicle to network V2N technology. The signals to be sent may include:
1. Identify as a charging point
2. GPS and/or Postcode
3. Type, AC, Wireless, or DC fast charge
4. Engaged or not Engaged
5. If Engaged time until vehicle is fully charged
6. Tethered or Untethered
7. Charging capacity KWH Max and currently available
8. Billable Rate
9. CCTV Security Monitored
10. Automatic number/licence plate recognition
11. Vehicle identification verification
12. Reserve the charger or not reserve, Time limited
13. Reversible and requesting power at a given price per KWH
14. Any other signal or information deemed useful for giving or receiving an electric charge.

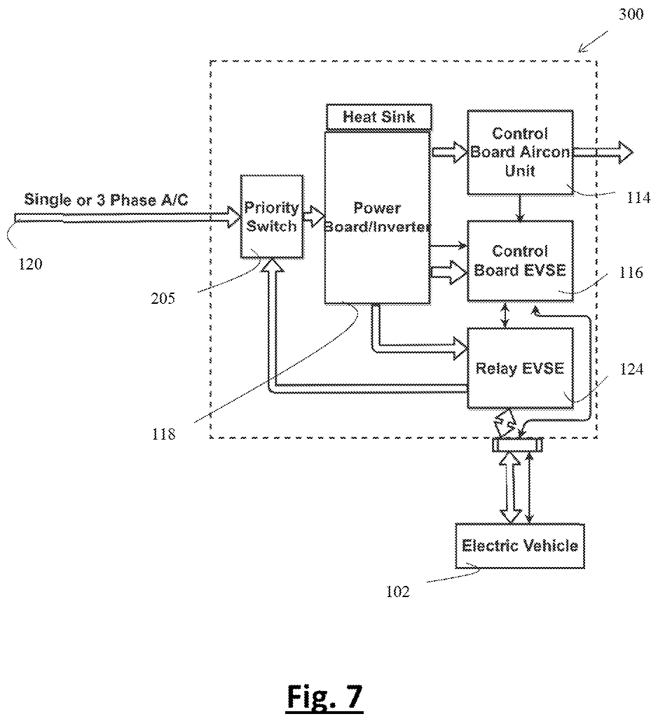

Referring to FIG. 7 there is illustrated another electric vehicle hybrid air conditioning system 300 configured for charging an electric vehicle 102, and is also in accordance with the present teaching. The electric vehicle hybrid air conditioning system 300 is substantially similar to the hybrid air conditioning systems 100 and 200 and like components are indicated by similar reference numerals. The hybrid air conditioning system 300 is configured to operate in a bidirectional mode. AC power from the power source 120 is bidirectional to and from the electric vehicle 102 which allows the air conditioner unit 102 to be powered from the charge of a battery of the electric vehicle 102. It will therefore be appreciated by those skilled in the art that the electric vehicle 102 provides a secondary power source to the air conditioning unit 105. This may be achieved using bidirectional EVSE equipment combined with the priority switch 205 relay or another form of control. The decision to reverse the charge may be done by one or more of the following options: from within the vehicle 102, automatically in case of a power cut, from an app controlled by the user, by manual control from the electric vehicle hybrid air conditioning system or other means. The returned power may be used only for use by the air conditioner unit 102 or may be diverted for use by secondary electrical appliances or stored for future use. There may be an ability to limit the available charge drawn from the electric vehicle 102 in particular to allow for charge remaining in the electric vehicle 102 in case of a power outage or if the electric vehicle 102 is required for emergency use.

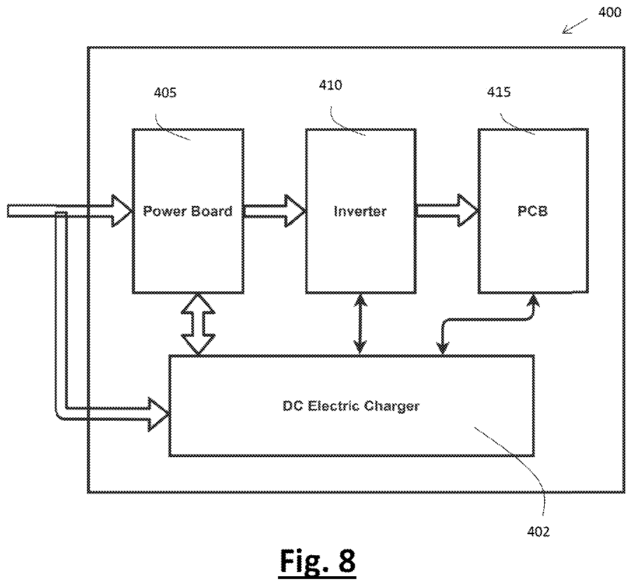

Referring to FIG. 8 there is illustrated another electric vehicle hybrid air conditioning system 400 configured for charging an electric vehicle 102, and is also in accordance with the present teaching. The electric vehicle hybrid air conditioning system 400 is substantially similar to the electric vehicle hybrid air conditioning systems 100, 200, 300 and like components are indicated by similar reference numerals. The electric vehicle hybrid air conditioning system 400 is configured in a direct current charger mode 4 and includes a DC electric charger 402. An inverter 410 and a PCB 415 may be operably coupled to the power board 405 and the DC electric charger 402. A power converter may be housed within the air conditioner or it can be housed in a separate unit connected to the air conditioner depending on space and cooling configuration required. The power board 405 can be integrated with the Mode 4 charger or can be separate depending on the large power requirements needed. At all times the air conditioning unit 102 will have the power it requires to optimally function and any and all power will be made available to the air conditioner should it be required in the case of limited power supply from grid or other source as available. This indicates that the priority on power inputted to the system will be given to the air conditioning unit 102 or vice versa. It is envisaged that the electric charger may be a wireless EV charger.

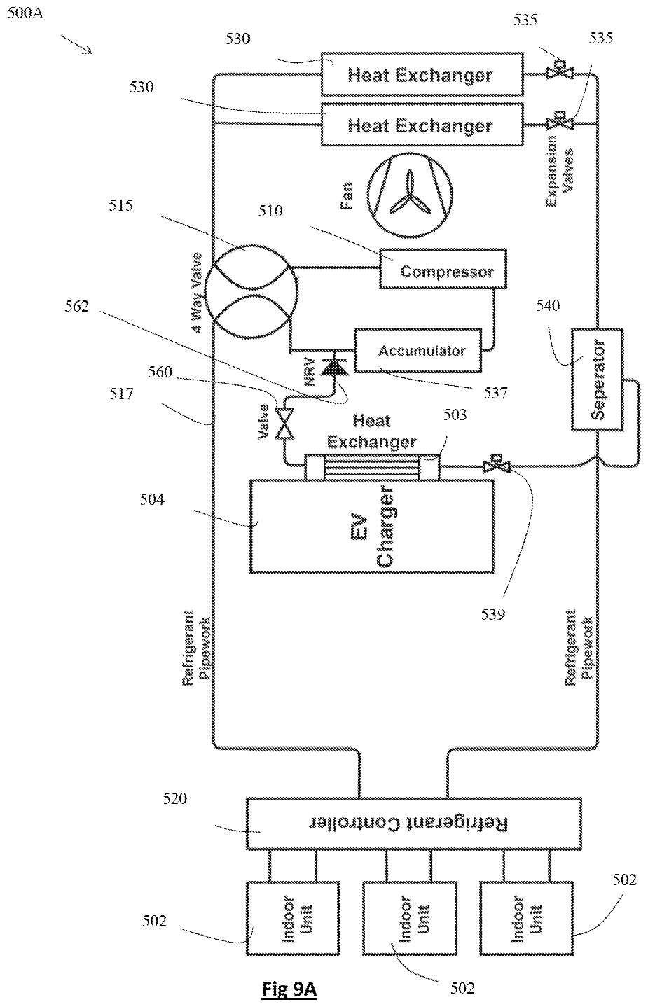

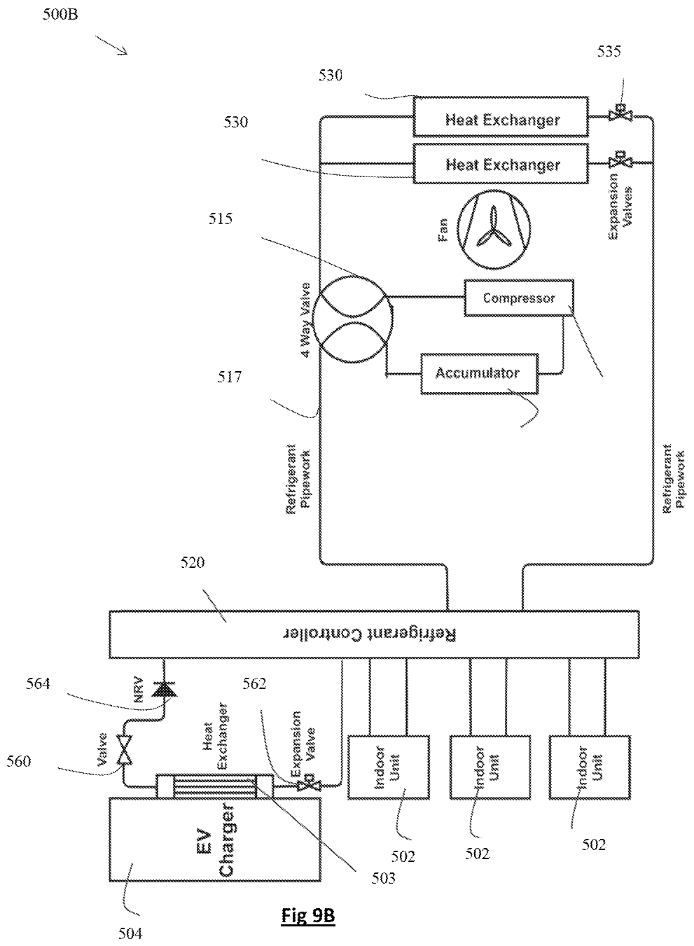

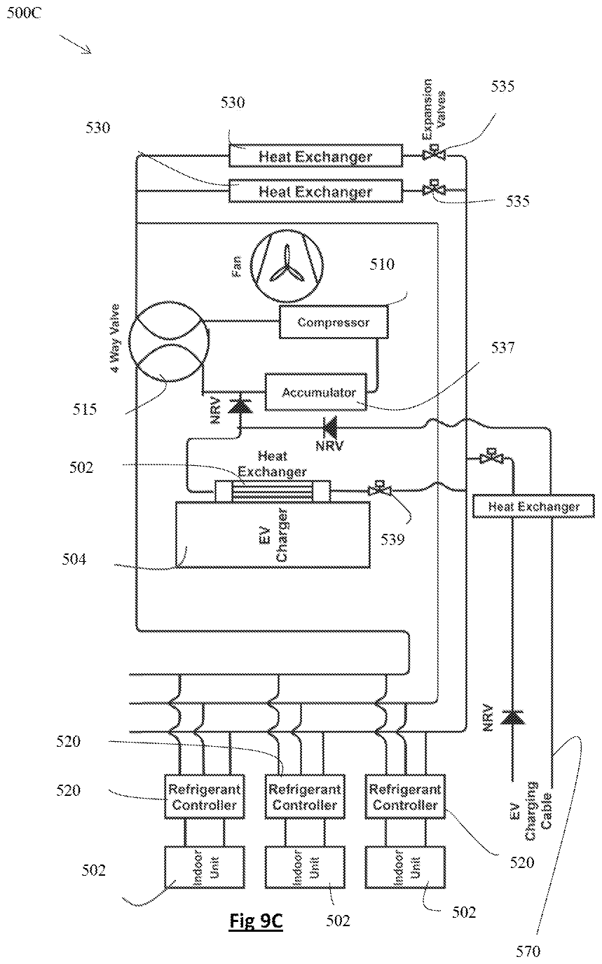

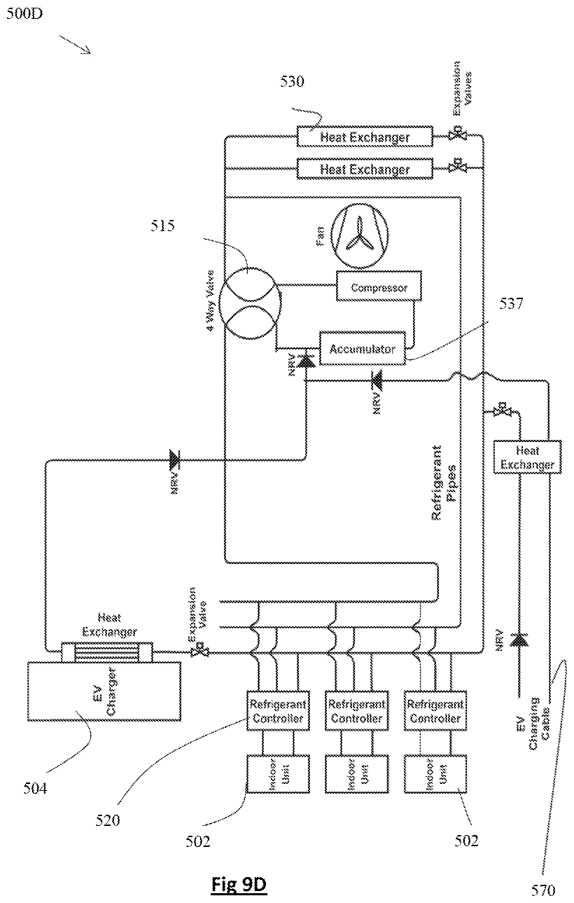

FIG. 9A illustrates another exemplary electric vehicle hybrid air conditioning system 500A and like components with reference to the previously described systems are indicated by similar reference numerals. The electric vehicle hybrid air conditioning system 500 includes a cooling means and in the exemplary embodiment the cooling means comprises a cooling loop circuit associated with an EV charger 504 on a two pipe variable refrigerant flow system. This is an example only and not an exhaustive method of configuring an EV charger 504 to a cooling loop circuit of an air conditioner. A heat exchanger indoor unit 502 calls for heating. A compressor 510 compresses refrigerant gas to a high pressure hot gas. The gas passes through a 4 way valve 515 and flows through pipework 517 to a refrigerant controller 520 and onto the indoor units 502, Cooled liquid is returned to heat exchangers 530 through an expansion valve 535 where it changes phase to a gas once more and back to an accumulator 537. On the return refrigerant pipe during a heating cycle a separator 540 allows for the cooled refrigerant to be rerouted through the cooling loop circuit of the EV charger 504. The cooled liquid passes through the expansion valve 539 and through a heat exchanger 503 of the EV charger 504 recovering heat from the charging process and returning the heated refrigerant back through a valve 560 and non-return valve 562 into the accumulator 537. This recovered heat will improve coefficient of performance of the air conditioning system on a heating cycle. The system also works on reverse cycle cooling. It will be appreciated by those skilled in the that the indoor unit 502 may be but not limited to a refrigerant to air, refrigerant to water or refrigerant to another medium.

FIG. 9B illustrates another exemplary electric vehicle hybrid air conditioning system 500B which is also in accordance with the present teaching. The electric vehicle hybrid air conditioning system 500B is substantially similar to the electric vehicle hybrid air conditioning system 500A and like components are indicated by similar reference numerals. The electric vehicle hybrid air conditioning system 500B is a further configuration for attaching a cooling loop circuit for an EV charger to the 2 pipe variable refrigerant flow system. In FIG. 9B the cooling loop circuit has been attached to the refrigerant controller box of the system. This configuration has the advantage of allowing an electric charger to be placed at a distance from the air conditioning unit while maintaining the advantage of heat recovery through the expansion valve 564, across the heat exchanger 503, through the valve 560 and non-return valve 562 to recover the heat and in turn increasing the coefficient of performance of the system in a heating cycle.

FIG. 9C illustrates another exemplary electric vehicle hybrid air conditioning system 500C which is also in accordance with the present teaching. The electric vehicle hybrid air conditioning system 500C is substantially similar to the electric vehicle hybrid air conditioning system 500A and like components are indicated by similar reference numerals. The electric vehicle hybrid air conditioning system 500C is a further example of an EV charger added to a 3 pipe variable refrigerant flow system. The function is very similar to that of the two pipe system described in FIG. 9A. The system 5000 comprises of a 3 pipe system with each indoor heat exchanger 502 having its own refrigerant controller 520. The separator has been removed in this example for a variable flow system of this configuration due to the refrigerant pipe will always have sufficient liquid refrigerant for cooling the EV charger during a charging cycle. As in FIG. 9A the return pipe from the EV charger 504 returns the recovered heat to the accumulator 537 increasing the coefficient of performance of the system during a heating cycle. An optional feature shown in the system 5000 is the possible integration of a heat exchanger cooling loop circuit which can be used to cool an electric vehicle cable operating 570 at high power. The cooling loop circuit for a charging cable can be integrated into both 2 and 3 pipe variable refrigerant flow systems.

FIG. 9D illustrates another exemplary electric vehicle hybrid air conditioning system 500D which is also in accordance with the present teaching. The electric vehicle hybrid air conditioning system 500D is substantially similar to the electric vehicle hybrid air conditioning system 500C and like components are indicated by similar reference numerals. The system 500D is a further configuration of a 3 pipe variable refrigerant flow system with the EV charger connected in a similar manner as an indoor unit. The EV charger 504 is required to only be connected to the return line for cooling and will function for cooling in forward or reverse cycle. The advantage of this setup is it allows the EV charger 504 to be configured at a distance from the air conditioner while maintaining the benefits of improving the coefficient of performance during a heating cycle.

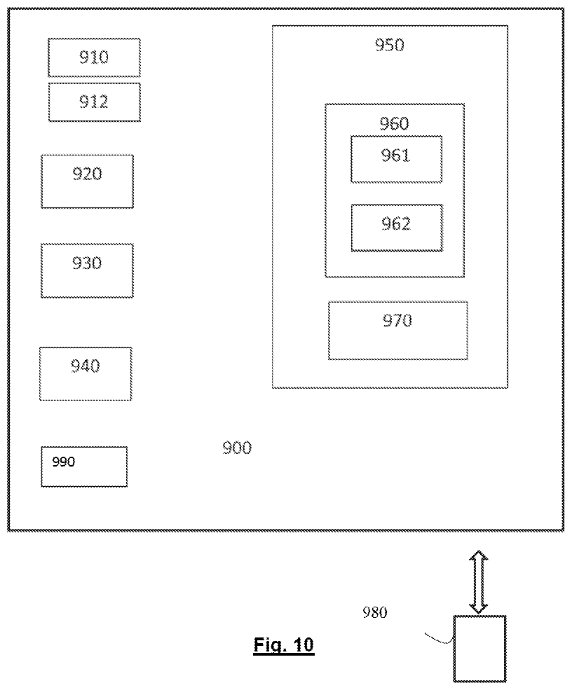

FIG. 10 is a block diagram illustrating a configuration of the control means which may be provided by a computing device 900. The computing device 900 includes various hardware and software components that function to perform processes according to the present disclosure. The computing device 900 may be embodied as one of numerous general purpose or special purpose computing system environments or configurations. Examples of well-known computing systems, environments, and/or configurations that may be suitable for use with the present disclosure include, but are not limited to, personal computers, server computers, cloud computing, hand-held or laptop devices, multiprocessor systems, microprocessor, microcontroller or microcomputer based systems, set top boxes, programmable consumer electronics, ASIC or FPGA core, DSP core, network PCs, minicomputers, mainframe computers, distributed computing environments that include any of the above systems or devices, and the like.

Referring to FIG. 10, the computing device 900 comprises a user interface 910, a processor 920 in communication with a memory 950, and a communication interface 930. The processor 920 functions to execute software instructions that can be loaded and stored in the memory 950. The processor 920 may include a number of processors, a multi-processor core, or some other type of processor, depending on the particular implementation. The memory 950 may be accessible by the processor 920, thereby enabling the processor 920 to receive and execute instructions stored on the memory 950. The memory 950 may be, for example, a random access memory (RAM) or any other suitable volatile or non-volatile computer readable storage medium. In addition, the memory 950 may be fixed or removable and may contain one or more components or devices such as a hard drive, a flash memory, a rewritable optical disk, a rewritable magnetic tape, or some combination of the above.

One or more software modules 960 may be encoded in the memory 950. The software modules 960 may comprise one or more software programs or applications having computer program code or a set of instructions configured to be executed by the processor 920. Such computer program code or instructions for carrying out operations for aspects of the systems and methods disclosed herein may be written in any combination of one or more programming languages.

The software modules 960 may include at least a first application 961 and a second application 962 configured to be executed by the processor 920. During execution of the software modules 960, the processor 920 configures the computing device 900 to perform various operations relating to the embodiments of the present disclosure, as has been described above.

Other information and/or data relevant to the operation of the present systems and methods, such as a database 970, may also be stored on the memory 950. The database 970 may contain and/or maintain various data items and elements that are utilized throughout the various operations of the system described above. It should be noted that although the database 970 is depicted as being configured locally to the computing device 900, in certain implementations the database 970 and/or various other data elements stored therein may be located remotely. Such elements may be located on a remote device or server—not shown, and connected to the computing device 900 through a network in a manner known to those skilled in the art, in order to be loaded into a processor and executed.

Further, the program code of the software modules 960 and one or more computer readable storage devices (such as the memory 950) form a computer program product that may be manufactured and/or distributed in accordance with the present disclosure, as is known to those of skill in the art.

The communication interface 940 is also operatively connected to the processor 920 and may be any interface that enables communication between the computing device 900 and other devices, machines and/or elements. The communication interface 940 is configured for transmitting and/or receiving data. For example, the communication interface 940 may include but is not limited to a Bluetooth, or cellular transceiver, a satellite communication transmitter/receiver, an optical port and/or any other such, interfaces for wirelessly connecting the computing device 900 to the other devices.

The user interface 910 is also operatively connected to the processor 920. The user interface may comprise one or more input device(s) such as switch(es), button(s), key(s), and a touchscreen.

The user interface 910 functions to facilitate the capture of commands from the user such as an on-off commands or settings related to operation of the system described above. The user interface 910 may function to issue remote instantaneous instructions on images received via a non-local image capture mechanism.

A display 912 may also be operatively connected to the processor 920. The display 912 may include a screen or any other such presentation device that enables the user to view various options, parameters, and results. The display 912 may be a digital display such as an LED display. The user interface 910 and the display 912 may be integrated into a touch screen display.

The computing device 900 may reside on a remote cloud-based computer. In this embodiment, the vehicle 102 communicates with the computing device 900 via a Vehicle-to-External (V2X) communication capability. Accordingly, the software adapted to implement the system and methods of the present disclosure can also reside in the cloud. Cloud computing provides computation, software, data access and storage services that do not require end-user knowledge of the physical location and configuration of the system that delivers the services. Cloud computing encompasses any subscription-based or pay-per-use service and typically involves provisioning of dynamically scalable and often virtualised resources. Cloud computing providers deliver applications via the Internet, which can be accessed from a web browser, while the business software and data are stored on servers at a remote location.

In the cloud embodiment of the computing device 900, the software modules 960 and processor 920 may be remotely located on the cloud-based computer. The operation of the computing device 900 and the various elements and components described above will be understood by those skilled in the art with reference to the method and system according to the present disclosure.

Each of the vehicles 102 may have a portal disposed therein through which is communicable with the electric vehicle hybrid air conditioning system 100. For example the portal may comprise a display 980. The display 980 may include a screen or any other such presentation device that enables the user of the vehicle 102 to view various options or parameters. For example, the display may be configured to display data associated with the electric vehicle hybrid air conditioning systems received from the communication interface 940. The display 980 may be a digital display such as an LED display, and may include a graphical user interface. For example, the display may be a touch screen display in which a graphical user interface may be integrated. The vehicles 102 may be configured to run an application which implements the methods of the present disclosure. For example, the methods may be primarily aimed at users of mobile devices such as smartphones. The methods may be embodied as part of an application or ‘app’ on a mobile device.

The cloud server may be an Internet-based computing environment, and may be configured to be accessible by the vehicle 102, for example by a telematics unit, via the Internet or the world-wide-web. The cloud server may be configured to receive data from the vehicle 102. The cloud server may include suitable physical and/or virtual hardware operatively coupled over a network so as to perform specific computing tasks, such as tasks related to the examples of the method disclosed herein. For example, the cloud server may include a processor memory device(s), and communication interface. The processor may be configured to run software such as an application which implements the methods according to the present disclosure. The application may include computer readable code embedded on a non-transitory, tangible computer readable medium. The application may be configured for execution by a processor of each of the vehicles 102 to display data associated with electric vehicle hybrid air conditioning system 100 and/or data associated with vehicle 102.

It will be appreciated by those skilled in the art that the communication interface 940 of the electric vehicle hybrid air conditioning system 100 facilitates any input or output communication, digital, analogue or otherwise from the electric vehicle hybrid air conditioning systems 100, 200, 300, 400 to or from the vehicle 102 either directly or via the cloud. The vehicle 102 may include on-board diagnostics (OBD) which is an automotive term referring to self-diagnostic and reporting capability of a vehicle. OBD systems provide a vehicle owner or repair technician access to the status of the various vehicle sub-systems. Modern OBD implementations use a standardized digital communications port to provide real-time data in addition to a standardized series of diagnostic trouble codes, or DTCs, which allow one to rapidly identify and remedy malfunctions within the vehicle. Controller Area Network (CAN) bus is a vehicle bus standard designed to allow microcontrollers and devices to communicate with each other within a vehicle without a host computer. CAN bus is a message-based protocol, designed specifically for automotive applications but now also used in other areas such as aerospace, maritime, industrial automation and medical equipment.

The communication interface 940 of the electric vehicle hybrid air conditioning system 100 may be configured to interface with an OBD port of a vehicle and/or the CAN bus. The communication interface 940 may comprise computer circuitry configured to receive data associated with the battery of the electric vehicle 102 such as the level of charge, a predicted distance that the vehicle can travel based on the level of charge. The vehicle 102 may further include a GPS receiver. The computer circuitry may be configured to communicate with external computing devices including the cloud over a 3G/4G, Bluetooth or Wi-Fi connection. The electric vehicle hybrid air conditioning system 100 may further include a GPS receiver. The computer circuitry may be configured to communicate with external computing devices including the cloud over a 3G/4G, Bluetooth or Wi-Fi connection. It will be appreciated by those skilled in the art that the electric vehicle hybrid air conditioning systems 100, 200, 300, 400 are configured to communicate their location, their capacity, their charging capability, advertise their connection type available and its status whether available, charging or any other relevant operational status. In this way the electric vehicle hybrid air conditioning systems may advertise information to electric vehicles such that the electric vehicles which are in the vicinity of the electric vehicle hybrid air conditioning systems know their charging capabilities.

The electric vehicle hybrid air conditioning systems 100, 200, 300 and 400 may include a point of sale (POS) module 990. The POS module may be configured to allow users of electric vehicles to pay for electricity consumed when charging their battery using the electric vehicle hybrid air conditioning system. To consummate a purchase transaction an account number is read. The account number is then used to route a transaction authorisation request that is initiated by the POS module. The POS module may communicate with a digital wallet of the user. In a typical transaction using a credit or debit card, a cardholder wishing to complete a transaction (or make a payment) provides a card number together with other card details (such as a card expiry date, card code verification (CCV) number etc.) to a merchant at a point of sale (POS). The merchant transmits the card number and the details to an ‘acquirer’, i.e. a financial institution that facilitates and processes card payments made to the merchant. The acquirer then transmits an authorization request via a payment card network to an issuer or provider of the card used to make the payment.

The issuer processes the received request and determines whether or not the request is allowable. If the issuer determines that the payment request is allowable, an authorization response is transmitted via the payment card network to the acquirer and transfer of the payment amount to the merchant's account is initiated. Responsive to receiving the authorization response from the issuer, the acquirer communicates the authorization response to the merchant. In this manner, a card number may be used to effect a card payment to a merchant.

The display of the electric vehicle hybrid air conditioning system which may be any screen or touchpad which allows viewing, editing and/or selection of operational settings of any parameters associated with the air conditioning system including but not limited to: the limit on amps for EV charging, time limit for charging or any operational status of electric vehicle charging station.

The software modules 960 may comprise one or more software programs or applications for implementing the exemplary method as illustrated in the flow chart 1000 of FIG. 10, for example. Such computer program code or instructions for carrying out operations of the method may be written in any combination of one or more programming languages. In the exemplary embodiment a method for controlling an electric vehicle hybrid air conditioning system 100 is described. The method uses at least one air conditioning unit for conditioning the temperature of a space or medium; step 1010. At least one electrical vehicle supply equipment (EVSE) is used for charging at least one electric vehicle 102 located in the vicinity of the electric vehicle hybrid air conditioning system; step 1020. A control means is used for controlling the at least one air conditioning unit 105 and the at least one electrical vehicle supply equipment 100, step 1030.

The present disclosure is not limited to the embodiment(s) described herein but can be amended or modified without departing from the scope of the present disclosure. Additionally, it will be appreciated that in embodiments of the present disclosure some of the above-described steps may be omitted and/or performed in an order other than that described.

Similarly the words comprises/comprising when used in the specification are used to specify the presence of stated features, integers, steps or components but do not preclude the presence or addition of one or more additional features, integers, steps, components or groups thereof.

1. An electric vehicle hybrid air conditioning system configured for charging an electric vehicle; the electric vehicle hybrid air conditioning system comprising:
at least one air conditioning unit for conditioning the temperature of a space or medium;
at least one electrical vehicle supply equipment for charging at least one electric vehicle;
a control means for controlling the at least one air conditioning unit and the at least one EVSE;
wherein the control means comprises a power sensing circuit; and further wherein any components of the at least one air conditioning unit the at least one EVSE, and the control means are integrated on the same integrated circuit board or are separated to fit within a unit such that the power sensing circuit is operable to monitor and control power distribution therein.

2. The electric vehicle hybrid air conditioning system of claim 1, wherein the control means is operable to at least one of:
(i) give priority to the air conditioning unit over the at least one EVSE or vice versa;
(ii) prioritise power supply to the air conditioning unit over the at least one EVSE, or vice versa;
(iii) allow the electric vehicle to operate as a secondary power source for the air conditioning unit;
(iv) reverse power from the electric vehicle to the air conditioning unit.

3. (canceled)

4. The electric vehicle hybrid air conditioning system of claim 2; wherein the control means is operable to operate a master slave relationship between the at least one air conditioning unit and the at least one EVSE; or vice versa.

5. (canceled)

6. The electric vehicle hybrid air conditioning system as claimed in claim 1 wherein the control means comprises a signal monitoring circuit.

7. (canceled)

8. The electric vehicle hybrid air conditioning system as claimed in claim 1 wherein the control means comprises a first controller for controlling the at least one air conditioning unit; and a second controller for controlling the at least one EVSE.

9. The electric vehicle hybrid air conditioning system of claim 8; wherein the first controller is configured as a master; and the second controller is configured as a slave.

10. The electric vehicle hybrid air conditioning system as claimed in claim 1 further comprising at least one power converter for converting power from a power source to a suitable format for powering the air conditioning unit.

11. The electric vehicle hybrid air conditioning system as claimed in claim 10; wherein the at least one power converter is configured for converting power from the power source to a suitable format for charging the electric vehicle.

12. The electric vehicle hybrid air conditioning system as claimed in claim 1; wherein the power sensing circuit is operable for measuring power being fed to the air conditioning unit and/or the EVSE.

13. The electric vehicle hybrid air conditioning system as claimed in claim 1 wherein the control means is operable for at least one of:
(i) varying the supply of current to the electric vehicle based on an operational characteristic of the air conditioning unit;
(ii) reversing the direction of power flow in response to n operational characteristic of the air conditioning unit; and
(iii) reversing the direction of power flow in response to an operational characteristic of the power source.

14. The electric vehicle hybrid air conditioning system of claim 1 wherein the control means is configured for facilitating bidirectional power flow between EVSE, the air conditioning unit and the electric vehicle.

15. (canceled)

16. (canceled)

17. The electric vehicle hybrid air conditioning system claim 1 wherein the air conditioning unit comprises cooling means.

18. The electric vehicle hybrid air conditioning system of claim 17; further comprising a DC electric charger or a wireless EV charger.

19. The electric vehicle hybrid air conditioning system claim 18 wherein the cooling means comprises a cooling loop circuit and/or a charger cable cooling circuit.

20. The electric vehicle hybrid air conditioning system of claim 19; wherein heat is recovered by the hybrid air conditioning system from the cooling loop circuit.

21. The electric vehicle hybrid air conditioning system of claim 1 further comprising at least one of:
(i) a communication module for facilitating the transfer of data to and/or from the electric vehicle; and
(ii) a Point of Sale module.

22. (canceled)

23. A method for controlling an electric vehicle hybrid air conditioning system, the method comprising:
using at least one air conditioning unit for conditioning the temperature of a space or medium;
using at least one electrical vehicle supply equipment for charging at least one electric vehicle;
using a control means for controlling the at least one air conditioning unit and the at least one EVSE; wherein the control means comprises a power sensing circuit; and further wherein any components of the at least one air conditioning unit, the at least one EVSE, and the control means are integrated on the same integrated circuit board or are separated to fit within a unit such that the power sensing circuit is operable to monitor and control power distribution therein.

24. The method of claim 23; wherein at least one of (i) priority is assigned to the air conditioning unit over the at least one EVSE or vice versa, and (ii) power supply is prioritised to the air conditioning unit over the at least one EVSE or vice versa.

25. (canceled)

26. The method of claim 24, wherein a master slave relationship exists between the at least one air conditioning unit and the at least one EVSE; or vice versa.

27. The method as claimed in claim 23 further comprising: using the electric vehicle to operate as a secondary power source for the air conditioning unit.

28. The method as claimed in claim 23 further comprising at least one of: (i) sensing a power signal, and (ii) monitoring a signal.

29. (canceled)

30. The method as claimed in claim 23, further comprising: reversing power supply such that the electric vehicle supplies power to the air conditioning unit.

31. The method as claimed in claim 23, further comprising at least one of: (i) converting power from a power source to a suitable format for powering the air conditioning unit, and (ii) converting power from the power source to a suitable format for charging the vehicle.

32. (canceled)

33. The method as claimed in claim 23, further comprising: measuring power being fed to the air conditioning unit and/or the EVSE.

34. The method as claimed in claim 23, further comprising: varying the supply of power to the electric vehicle based on an operational characteristic of the air conditioning unit.

35. The method of claim 23, wherein bidirectional power flow is permitted between EVSE, the air conditioning unit and the electric vehicle.

36. The method of claim 23, further comprising at least one of: (i) reversing the direction of power in response to an operational characteristic of the air conditioning unit, and (ii) reversing the direction of power flow in response to an operational characteristic of the power source.

37. (canceled)

38. The method of claim 23, wherein heat is recovered from a charger cooling loop.

39. The method as claimed in claim 23, wherein data is transferred to and/or from the electric vehicle.

40. The method as claimed in claim 23, further comprising: completing a transaction to pay for electricity consumed when charging the electric vehicle using a Point of Sale module.

41. A computer-readable medium comprising non-transitory instructions which, when executed, cause a processor to carry out a method according to claim 23.
